(19) United States
(12) Patent Application Publication
(10) Pub. No.: US 2016/0169367 A1
(43) Pub. Date: Jun. 16, 2016

(54) AXLE CARRIER COVER DEFINING SUPPORT RIBS BETWEEN VEHICLE MOUNTING SURFACES

(71) Applicant: FORD GLOBAL TECHNOLOGIES, LLC, Dearborn, MI (US)

(72) Inventors: Brian Christian ORR, Macomb, MI (US); Gerald Stephen SZCZEPANSKI, Dearborn, MI (US)

(21) Appl. No.: 14/567,193

(22) Filed: Dec. 11, 2014

(51) Int. Cl. F16H 57/031; F16H 57/032; F16H 57/04; F16H 57/03

(52) U.S. Cl. CPC F16H 57/031; F16H 57/03; F16H 57/032; F16H 57/0412

(57) ABSTRACT

A cover for an axle carrier assembly having a carrier-mounting surface on a first side, vehicle-mounting surfaces on a second side, and first and second support ribs extending between the vehicle-mounting surfaces on the second side to provide support for the axle carrier assembly. The first and second support ribs may extend across the second side of the cover connecting the vehicle-mounting surfaces to each other. The first and second support ribs may extend opposite from and adjacent to the carrier-mounting surface. A section of the second support rib may extend below a horizontal centerline on the cover.

### TECHNICAL FIELD

This disclosure relates to covers for axle carriers and more specifically to covers for axle carriers for independent suspension axle assemblies.

### BACKGROUND

Automotive independent suspension axle assemblies often consist of a central carrier assembly flexibly connected to a frame of the vehicle with half shafts extending outwardly from the carrier assembly toward wheels which are connected to the vehicle by independently articulating suspensions. The axle carrier assembly commonly comprises a sealed housing and cover disposed around a differential assembly. The differential assembly includes a plurality of gears and is configured to couple an input shaft, which is connected to a drive shaft, to two output shafts, also known as half shafts. The inboard end of the half shaft extends within the carrier housing through bearings and retainers/seals disposed in the carrier housing.

The axle carrier assembly may be connected to transverse frame members of the vehicle via the carrier housing and the cover. Carrier housing and cover combinations are designed to withstand torsional and acceleration loading and are often substantial in size and weight. The carrier assembly is also designed to hold lubrication fluids for the differential and input and output components that transfer rotation/torque from the drive shaft, through the differential and to the half shafts. Weight reduction on these designs is often difficult. As well, the design must adequately handle the loads imparted into the housing and cover while at the same time not separate from each other or elastically or plastically deform in such a way that a leak may occur between the two.

### SUMMARY

One aspect of this disclosure is directed to a cover for an axle carrier. The cover is a casting having a first and a second side. The cover defines a substantially planar carrier-mounting surface extending continuously about a periphery of the first side. The carrier-mounting surface having a number of carrier-attachment holes defined therethrough. The cover defines two vehicle-mounting surfaces on the second side. Each of the two vehicle-mounting surfaces extends from the second side past the periphery of the first side. The cover also defines upper and lower ribs projecting from the second side and extending between the vehicle-mounting surfaces. The upper and lower ribs extend adjacent the carrier-attachment holes.

The carrier-mounting surface may be substantially quadrilateral in shape with rounded corners. The quadrilateral in shape may have an upper lateral segment opposing a lower lateral segment and two opposing vertical segments disposed between the four rounded corners. Each vehicle-mounting surface may have a vehicle-attachment hole defined therethrough. The vehicle-attachment holes may be disposed vertically below the upper lateral segment and laterally outwardly from the two opposing vertical segments. The upper rib may extend between the two vehicle mounting surfaces crossing the vertical segments of the quadrilateral shape and extending substantially adjacent to and vertically below the upper lateral segment. The lower rib may extend between the two vehicle mounting surfaces having first portions crossing the vertical segments of the quadrilateral, second portions extending substantially adjacent to and inboard from the vertical segments, and third portions extending substantially adjacent to and vertically above the lower lateral segment for a portion.

The second side of the cover may define a number of substantially parallel fins extending between the upper and lower ribs. The cover may be divided into upper and lower quadrants separated by horizontal and vertical centerlines. The vehicle-mounting surfaces may be located in upper quadrants. The upper rib may extend across the second side within the upper quadrants and across the vertical centerline. The lower rib may extend from the upper quadrants across the horizontal centerline into lower quadrants and across the vertical centerline in the lower quadrants.

The cover may define a carrier lube drain hole disposed in-line with the lower rib. The cover may define a sensor access hole disposed in-line with the upper rib. The cover may be cast in iron, aluminum, or another appropriate metal. The carrier-mounting and vehicle-mounting surfaces may be machined surfaces on the casting. The carrier-attachment, vehicle-attachment, lube drain, and sensor access holes may be drilled into the casting.

Another aspect of this disclosure is directed to another embodiment of an axle carrier. This axle carrier has a carrier-mounting surface on a first side and two vehicle-mounting surfaces disposed on a second side radially outside of the carrier-mounting surface, similar to the above described cover. In this cover, the carrier-mounting surface has an upper portion and a lower portion. An upper support rib projects from the second side extendedly connecting the vehicle-mounting surfaces adjacent the upper portion of the carrier-mounting surface, while a lower support rib projects from the second side connecting the vehicle-mounting surfaces with a segment extending adjacent the lower portion of the carrier-mounting surface.

This cover may define a substantially horizontal centerline. The vehicle-mounting surfaces and the upper support rib may be disposed above the centerline. The lower support rib may cross over the horizontal centerline having a segment extending below the centerline. The cover may also define a number of continuous fins extending between the upper and lower support ribs.

A further aspect of this disclosure is directed to an axle carrier assembly for an independent suspension vehicle. The assembly has a cover sealably connected to a carrier housing. The cover is also connected to the vehicle via two vehicle-mounting surfaces disposed above a cover centerline. This cover defines a first support rib extending continuously between the two vehicle-mounting surfaces above the centerline, and a second support rib extending continuously between the two vehicle-mounting surfaces with a segment passing below the centerline.

The axle carrier assembly may have a carrier housing defining an inlet hole for receiving torque from a drive shaft and two opposing output holes for sending torque to the half shafts. The carrier housing may be connected to the vehicle. The carrier housing may be connected to the vehicle via a first transverse frame member.

The cover in this assembly may define a substantially planar carrier-mounting surface extending continuously around a periphery of a first side. The cover may define a number of carrier-attachment holes disposed along the carrier-mounting surface extending through the cover to a second side. The assembly may have a number of carrier-fasteners extending through the carrier-attachment holes and into the carrier housing to connect the cover to the carrier housing.

The cover in this assembly may define two vehicle-mounting surfaces on a second side. The cover may define two vehicle-attachment holes extending through the cover, each located at a vehicle-mounting surface. The vehicle-attachment holes may be disposed radially outside of the carrier-attachment holes. The assembly may have at least one vehicle-fastener extending through each of the vehicle-attachment holes and into a vehicle component to connect the cover to the vehicle. The vehicle component may be a transversely extending frame member.

The cover may define a number of the carrier-attachment holes disposed radially outside of the first and second support ribs. The cover may define at least one of the number of the carrier-attachment holes disposed radially inside of the first and second support ribs.

The above aspects of this disclosure and other aspects will be explained in greater detail below with reference to the attached drawings.

### BRIEF DESCRIPTION OF THE DRAWINGS

FIG. 1 is an outside view of a cover for an axle carrier.

FIG. 2 is an inside view of a cover for an axle carrier.

FIG. 3 is a partial bottom view of an axle carrier assembly on a vehicle.

FIG. 4 is an outside view of a cover for an axle carrier having a number of fins.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

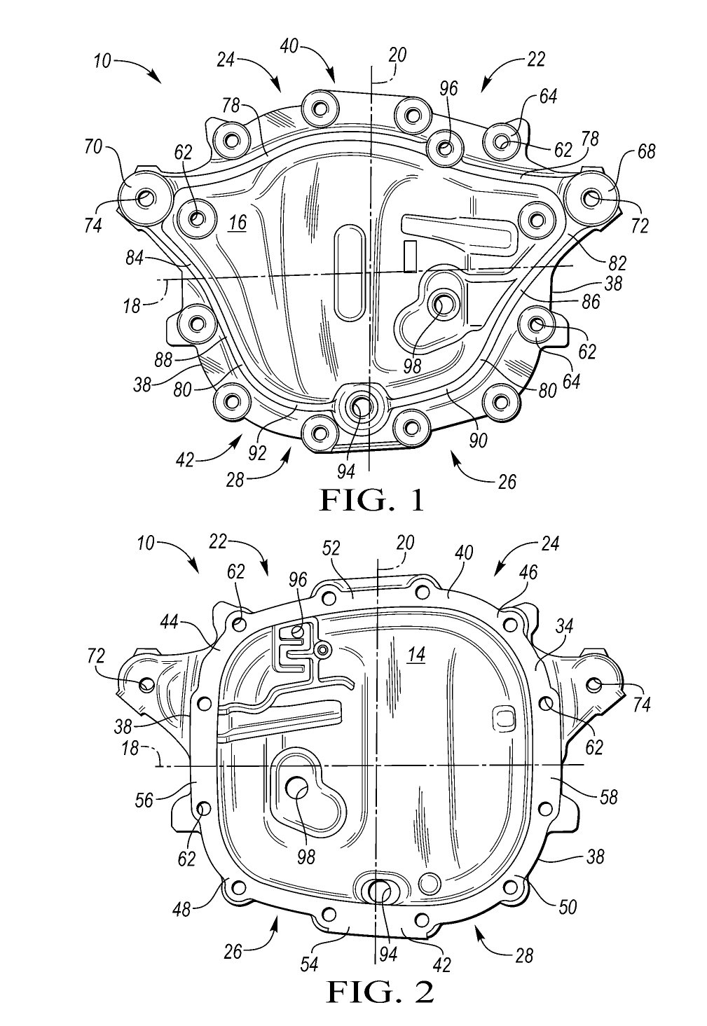

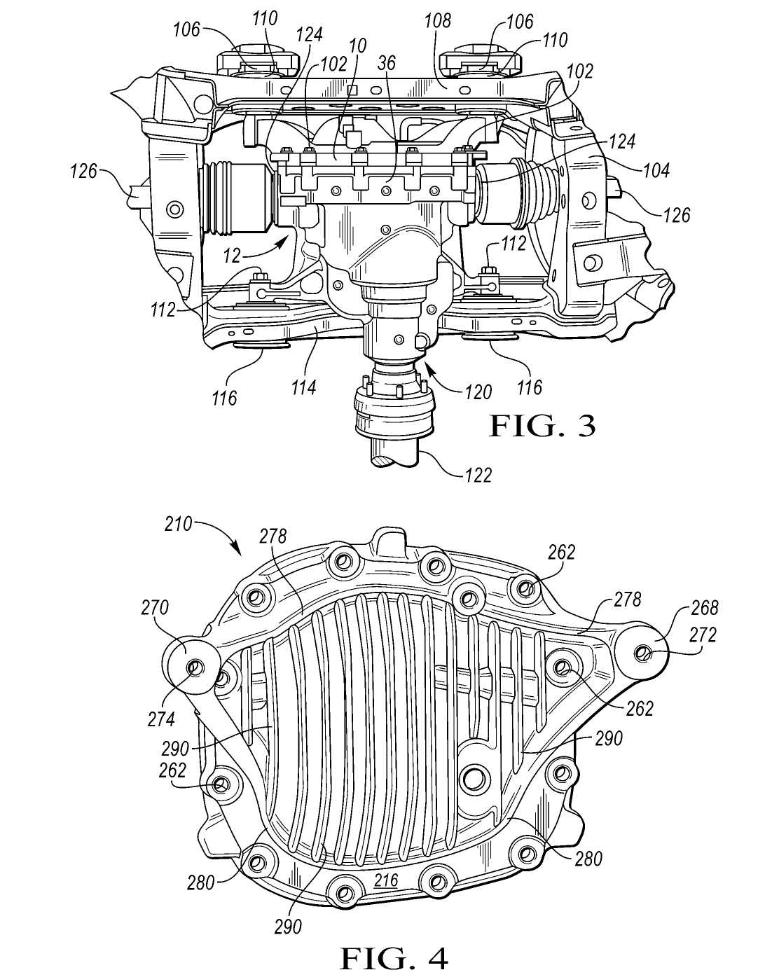

FIGS. 1 and 2 show outside and inside views, respectively, of a cover 10 for an axle carrier assembly 12 (see FIG. 3). Cover 10 may be primarily formed as a metal casting. Cover 10 may be iron or aluminum, but other metals may be used. The cover has a first side 14 opposite a second side 16. A portion of the first side 14 may be concave and a portion of the second side may be convex. The cover 10 may have a substantially horizontal centerline 18 and a substantially vertical centerline 20. The centerlines 18, 20 may divide the cover into upper quadrants 22, 24 and lower quadrants 26, 28. Although the terms upper and lower are used here, it should be understood that throughout this application these terms, as well as the terms horizontal and vertical, are merely relational terms to each other. Cover 10 may be turned in any direction such that the directional limitations may not have any correlation to an actual up, down, vertical, or horizontal direction from the Earth.

The first side 14 defines a carrier-mounting surface 34. The carrier-mounting surface 34 connects to the carrier housing 36 (see FIG. 3) to seal the cover 10 to the carrier housing 36. A gasket (not shown) may also be disposed between the cover 10 and carrier housing 36. The carrier-mounting surface 34 may be machined onto the first side 14. The carrier-mounting surface 34 may be substantially planar. The carrier-mounting surface 34 may extend continuously about a periphery 38 of the first side 14. The carrier-mounting surface 34 may have an upper portion 40 and a lower portion 42.

The carrier-mounting surface 34 may also be substantially quadrilateral in shape with rounded corner segments 44, 46, 48, 50, as shown here. The quadrilateral shape may have an upper lateral segment 52 extending between upper corner segments 44, 46. The quadrilateral shape may have an opposing a lower lateral segment 54 extending between lower corner segments 48, 50. As well, the quadrilateral shape may have two opposing vertical segments 56, 58 disposed between the rounded corner segments 44, 48 and 46, 50, respectively.

The cover 10 defines a number of carrier-attachment holes 62. The carrier-attachment holes 62 may be disposed along the carrier-mounting surface 34. Said another way, the carrier-mounting surface 34 may have a number of attachment holes 62 defined therethrough. The carrier-attachment holes 62 may extend through the cover 10 from the first side 14 to the second side 16. The carrier-attachment holes 62 may be drilled into the casting. The cover 10 may also define a fastener mating surfaces 64 disposed on the second side 16 for each carrier-attachment hole 62.

The cover 10 defines two vehicle-mounting surfaces 68, 70 for connecting a portion of the axle carrier assembly 12 to a vehicle (see FIG. 3). The vehicle-mounting surfaces 68, 70 may be disposed on the second side 16 of the cover 10. The vehicle-mounting surfaces 68, 70 may be machined onto the second side 16 of the casting. The vehicle-mounting surfaces 68, 70 may be disposed radially outside of the carrier-mounting surface 34. The vehicle-mounting surfaces 68, 70 may extend past the periphery 38 of the first side 14. The vehicle-mounting surfaces 68, 70 may be disposed above the horizontal centerline 18. The vehicle-mounting surfaces 68, 70 may be located in adjacent quadrants 22, 24, 26, 28. The vehicle-mounting surfaces 68, 70 may be located in the upper quadrants 22, 24.

Two vehicle-attachment holes 72, 74 may extend through the cover 10 from the first side 14 to the second side 16. Each vehicle-attachment hole 72, 74 may be located at a respective vehicle-mounting surface 68, 70. Said another way, each vehicle-mounting surface 68, 70 may have a vehicle-attachment hole 72, 74 defined therethrough. The vehicle-attachment holes 72, 74 may be disposed radially outside of the carrier-attachment holes 62. The vehicle-attachment holes 72, 74 may be disposed vertically below the upper lateral segment 52 of the quadrilateral shaped carrier-mounting surface 34. The vehicle-attachment holes 72, 74 may be disposed laterally outwardly from the two opposing vertical segments 56, 58 of the quadrilateral shaped carrier-mounting surface 34.

The cover 10 defines a first support rib 78 extending between the vehicle-mounting surfaces 66, 68. The first support rib 78 may extend continuously between the two vehicle-mounting surfaces 68, 70 connecting them to each other. The first support rib 78 may project outwardly from the second side 16. The first support rib 78 may also be referred to as an upper support rib 78. The first support rib 78 may be disposed above the horizontal centerline 18. The first support rib 78 may extend between the vehicle-mounting surfaces 68, 70 adjacent a number of carrier-attachment holes 62. A section of the first support rib 78 may extend adjacent an upper portion 40 of the carrier-mounting surface 34. The first support rib 78 may extend within the upper quadrants 22, 24 and across the vertical centerline 20. The first support rib 78 may extend between the two vehicle-mounting surfaces 68, 70 crossing the vertical segments 56, 58 and extending substantially adjacent to and vertically below the upper lateral segment 52 of the quadrilateral shaped carrier-mounting surface 34.

The cover 10 defines a second support rib 80 extending between the vehicle-mounting surfaces 66, 68. The second support rib 80 may extend continuously between the two vehicle-mounting surfaces 68, 70 connecting them to each other. The second support rib 80 may project outwardly from the second side 16. The second support rib 80 may also be referred to as an lower support rib 80. The second support rib 80 may cross the horizontal centerline 18 with a section extending below the horizontal centerline 18. The second support rib 80 may extend between the vehicle-mounting surfaces 68, 70 adjacent a number of the carrier-attachment holes 62. A section of the second support rib 80 may extend adjacent a lower portion 42 of the carrier-mounting surface 34.

The second support rib 80 may extend from the upper quadrants 22, 24 across the horizontal centerline 18 into lower quadrants 26, 28 and meet at the vertical centerline 20 in the lower quadrants 26, 28. The second support rib 80 may have end sections 82, 84 extending from the two vehicle mounting surfaces 68, 70, crossing the vertical segments 56, 58 of the quadrilateral shaped carrier-mounting surface 34 on the opposite side of the cover 10. The second support rib 80 may have intermediate sections 86, 88 extending from the end sections 82, 84 and extending substantially adjacent to and inboard from the vertical segments 56, 58. The second support rib 80 may have central sections 90, 92 extending from the intermediate sections 86, 88 and extending substantially adjacent to and vertically above the lower lateral segment 54.

A number of the carrier-attachment holes 72 may be disposed radially outside of the first and second support ribs 78, 80. At least one of the number of the carrier-attachment holes 72, however, may be disposed radially inside of the first and second support ribs 78, 80. The tracking of the first and second support ribs 78, 80, as defined above, allows for a lightweight casting to be utilized while still providing the support for the axle carrier assembly 12 while also maintaining a sufficient seal with the carrier housing 36. The first and second support ribs 78, 80 extend adjacent and cross over the opposite side of the carrier-mounting surface to prevent elastic and plastic deformation to occur between the cover 10 and carrier housing 36 which may allow for a leak path for any lubricant (not shown) held within the axle carrier assembly 12.

The cover 10 may define a number of other features and holes machined and drilled into the casting. The cover 10 may define a carrier lube drain hole 94. The carrier lube drain hole 94 may be disposed in-line with the lower rib 80. The cover 10 may define a sensor access hole 96. The sensor access hole 96 may be disposed in-line with the upper rib 78. The cover 10 may also define a lubricant level check port 98. The lubricant level check port 98 may not be in-line with either rib 78, 80.

FIG. 3 shows a cover 10 sealably connected to a carrier housing 36 via a number of carrier-fasteners 102. The carrier-fasteners 102 extend through the carrier-attachment holes 62 (see FIGS. 1 and 2) and into the carrier housing 36 to connect the cover to the carrier housing 36. The cover 10 being sealably attached to the carrier housing 36 makes up the outer surfaces of the axle carrier assembly 12 which holds the lubrication for the differential assembly (not shown). The cover 10 and carrier housing 36 combination also allow for the axle carrier assembly 12 to be connected to the vehicle 104 providing for the opportunity to have an independent suspension.

The Cover 10 is shown connected to a vehicle 104 via vehicle-fasteners 106. The vehicle-fasteners 106 extend through a vehicle component 108 and into the vehicle-attachment holes 72, 74 (see FIGS. 1 and 2) to connect the cover 10 to the vehicle 104. Vehicle-attachment holes 72, 74 may be threaded, or the vehicle-fasteners 106 may include a bolt and nut combination to connect the cover 10 to the vehicle 104 though the vehicle-attachment holes 72, 74. The vehicle component 108 may be a first transversely extending frame member 108. The cover 10 may also be connected to the vehicle 104 via a rubber grommet or damping material 110.

The carrier housing 36 may be connected to the vehicle 104 via carrier-to-vehicle fasteners 112. The carrier-to-vehicle fasteners 112 may be connected to a second transversely extending frame member 114. The carrier housing 36 may also be connected to the vehicle 104 via a rubber grommet or damping material 116. The carrier housing 36 defines an inlet hole 120 for receiving torque from a drive shaft 122. The carrier housing 36 defines two opposing output holes 124 for sending torque to half shafts 126.

FIG. 4 shows a cover 210 having a second side 216 with a number of carrier-attachment holes 262 extending therethrough. The cover 210 has two vehicle-mounting surfaces 268, 270, each with a vehicle-attachment hole 272, 274 extending therethrough. The cover 210 also has an upper and lower support ribs 278, 280 extending between the two vehicle-mounting surfaces 268, 270 adjacent to the carrier-attachment holes 262. In this embodiment, the cover 210 has a number of fins 290 projecting from the second side 216. The fins 290 may be substantially parallel fins 290. A number of the fins 290 may be continuous fins 290 connectedly extending between the an upper and lower support ribs 278, 280. The fins 290 may provide for additional rigidity and support for the cover 210. The fins 290 may also provide for additional cooling for an axle carrier assembly 12 by providing more surface area.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. An axle carrier cover comprising:
a casting having a first and a second side;
a substantially planar carrier-mounting surface extending continuously about a periphery of the first side, the carrier-mounting surface having a number of carrier-attachment holes defined therethrough;
two vehicle-mounting surfaces extending from the second side past the periphery of the first side; and
upper and lower ribs projecting from the second side and extending between the vehicle-mounting surfaces adjacent the carrier-attachment holes.

2. The cover of claim 1 wherein the carrier-mounting surface is substantially quadrilateral in shape with rounded corners, the carrier-mounting surface having an upper lateral segment opposing a lower lateral segment, and two opposing vertical segments disposed between the rounded corners.

3. The cover of claim 2 wherein each vehicle-mounting surface has a vehicle-attachment hole defined therethrough and the vehicle-attachment holes are disposed vertically below the upper lateral segment and laterally outwardly from the two opposing vertical segments.

4. The cover of claim 3 wherein the upper rib extends between the two vehicle mounting surfaces crossing the vertical segments and extending substantially adjacent to and vertically below the upper lateral segment.

5. The cover of claim 3 wherein the lower rib extends between the two vehicle mounting surfaces crossing the vertical segments, extending substantially adjacent to and inboard from the vertical segments, and extending substantially adjacent to and vertically above the lower lateral segment.

6. The cover of claim 1 wherein the second side of the cover defines a number of substantially parallel fins extending between the upper and lower ribs.

7. The cover of claim 1 wherein the casting has upper and lower quadrants separated by horizontal and vertical centerlines, the vehicle-mounting surfaces are located in upper quadrants, the upper rib extends within the upper quadrants and across the vertical centerline, and the lower rib extends from the upper quadrants across the horizontal centerline into lower quadrants and across the vertical centerline in the lower quadrants.

8. The cover of claim 1 defining a carrier lube drain hole disposed in-line with the lower rib.

9. The cover of claim 1 defining a sensor access hole disposed in-line with the upper rib.

10. The cover of claim 1 wherein the casting is iron.

11. An axle carrier assembly for an independent suspension vehicle comprising:
a cover sealably connected to a carrier housing and connected to the vehicle via two vehicle-mounting surfaces disposed above a cover centerline, wherein the cover defines a first support rib extending continuously between the two vehicle-mounting surfaces above the centerline, and a second support rib extending continuously between the two vehicle-mounting surfaces with a segment passing below the centerline.

12. The axle carrier assembly of claim 11 wherein the cover defines a substantially planar carrier-mounting surface extending continuously around a periphery of a first side, a number of carrier-attachment holes disposed along the carrier-mounting surface extending through the cover to a second side, and further comprising a number of carrier-fasteners extending through the carrier-attachment holes and into the carrier housing to connect the cover to the carrier housing.

13. The axle carrier assembly of claim 12 wherein the cover defines two vehicle-attachment holes extending through the cover, each disposed at a vehicle-mounting surface, and further comprising a vehicle-fastener extending through the vehicle-attachment holes and into a vehicle component to connect the cover to the vehicle.

14. The axle carrier assembly of claim 13 wherein the cover defines the vehicle-mounting surfaces on the second side, and the vehicle-attachment holes are disposed radially outside of the carrier-attachment holes.

15. The axle carrier assembly of claim 12 wherein a number of the carrier-attachment holes are disposed radially outside of the first and second support ribs.

16. The axle carrier assembly of claim 12 wherein at least one of the number of the carrier-attachment holes are disposed radially inside of the first and second support ribs.

17. The axle carrier assembly of claim 11 wherein the carrier housing defines an inlet hole for receiving torque from a drive shaft and two opposing output holes for sending torque to half shafts.

18. An axle carrier cover comprising:
a carrier-mounting surface on a first side;
two vehicle-mounting surfaces disposed on a second side and radially outside of the carrier-mounting surface;
an upper support rib projecting from the second side connecting the vehicle-mounting surfaces and extending adjacent an upper portion of the carrier-mounting surface; and
a lower support rib projecting from the second side connecting the vehicle-mounting surfaces and extending adjacent a lower portion of the carrier-mounting surface.

19. The cover of claim 18 further comprising:
a substantially horizontal centerline, wherein the vehicle-mounting surfaces and the upper support rib are disposed above the centerline and the lower support rib crosses the centerline with a segment extending below the centerline.

20. The cover of claim 18 further comprising:
a number of continuous fins extending between the upper and lower support ribs.
